(19) United States
(12) Patent Application Publication
(10) Pub. No.: US 2001/0037230 A1
(43) Pub. Date: Nov. 1, 2001

(54) Method of facilitating a move of household goods

(76) Inventors: William M. Raveis JR., Fairfield, CT (US); John U. Peverini, North Haven, CT (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 09/798,656

(22) Filed: Mar. 1, 2001

Related U.S. Application Data
(63) Continuation-in-part of application No. 09/459,234, filed on Dec. 10, 1999.

(51) Int. Cl. G06F 17/60

(52) U.S. Cl. 705/9

(57) ABSTRACT

A method is disclosed for facilitating a move of household goods for a customer which includes the steps of receiving contact information relating to a customer from a referral source, contacting the customer to perform a pre-move needs analysis, offering the customer at least one moving service based upon the pre-move needs analysis, sending an order to a vendor for a selected moving service on behalf of the customer, and performing a set of predefined tasks based upon a schedule of events related to the selected moving service to ensure the customer's satisfaction throughout the move.

### CROSS-REFERENCE TO RELATED APPLICATIONS

The subject application is a continuation-in-part of U.S. Appln. Ser. No. 09/459,234 filed Dec. 10, 1999, the disclosure of which is herein incorporated by reference in its entirety.

### BACKGROUND OF THE INVENTION

1. Field of the Invention

The subject invention is directed to a business method for facilitating a move of household goods, and more particularly, to a move management system for arranging, providing and monitoring home moving services to ensure customer satisfaction before, during and after the moving process.

2. Background of the Related Art

According the U.S. Census Bureau, on average, a person moves twelve times in their life or about once every six years. It is widely accepted that moving is one of the most stressful events in life. As a result, many small and large corporations outsource the relocation process to specialized relocation companies who manage the entire moving process for their employees. Relocations companies serving individual homeowners are less commonplace in the real estate industry.

Heightened consumer expectations and new competition created by the emerging Internet economy are threatening traditional business models. Real Estate brokers and agents, as well as relocation companies, are no exception. As competition increases, companies must discard their traditional business philosophies of the past and adopt new innovative ways to maintain customer loyalty and profitability.

It would be beneficial therefore, to provide a new and innovative move management system for home buyers and sellers that centrally monitors information on a daily basis in such a manner so as to effectively direct strategic activities throughout the moving process, thereby ensuring customer satisfaction.

### SUMMARY OF THE INVENTION

The subject invention is directed to a new and useful method of facilitating a move of household goods for a customer. The method includes the steps of receiving contact information relating to a customer from a referral source, contacting the customer by telephone to perform a pre-move needs analysis, offering the customer at least one moving service based upon the pre-move needs analysis, sending an order to a vendor for a selected moving service on behalf of the customer by facsimile or e-mail, and performing a set of predefined tasks based upon a schedule of events related to the selected moving service to ensure the customer's satisfaction throughout the move.

In accordance with the subject invention, the moving service is selected from a group of moving services including transportation services, truck rental services, box provision services, container services, and storage facility services. The method further includes the steps of creating a computerized move profile based upon the needs analysis, entering a set of dates into the move profile related to a selected moving service, and performing a set of predefined tasks related to the selected moving service based upon the set of dates entered into the move profile.

In a particular embodiment of the subject invention, the method involves a move coordinator who facilitates communication between a customer and local commercial carriers, i.e., van lines and moving companies. In such a method, there is an initial step of receiving contact information relating to a customer from a referral source. The referral source is generally a regional or national move consultant who is associated with the move coordinator. Based upon the contact information, the move coordinator contacts the customer to perform a pre-move survey and determine the number of cost estimates or bids required by the customer. The method further includes the steps of contacting a number of carriers corresponding to the number of cost estimates required by the customer and arranging for each carrier to conduct a survey of the customer's home to enable each carrier to determine a cost estimate for the move.

The method also includes the steps of receiving a cost estimate from each carrier based upon the survey conducted thereby, conferring with the customer to facilitate the selection of a carrier based upon the cost estimates received from each carrier, and subsequently awarding a move to the carrier selected by the customer. Preferably, the method also includes the step of calculating a commission fee based upon the cost of the move and at least one business rule so as to generate a revenue stream for the move consultant as well as the referral source.

In accordance with a preferred embodiment of the subject invention, the step of arranging for each carrier to conduct a survey of the customer's home includes the step of scheduling surveys at predetermined time intervals, and the step of contacting each carrier in accordance with a rule defining the method of contact. The method further includes the steps of designating a time period for each carrier to contact the customer to schedule the survey, and designating a time period for each carrier to submit a cost estimate to the customer.

In addition, the method includes the step of contacting each carrier in accordance with a rule defining the method of contact and the step of designating a rule defining a method for submitting a cost estimates to the customer. The method further includes the steps of providing an order for service setting forth information relative to the move including such information as the size of the customer's home, the origination address, the destination address, preferred moving date and special handling needs such as for example, piano moving.

In accordance with a preferred embodiment of the subject invention, the method also includes the step of performing a set of prescheduled tasks to ensure the customer's satisfaction prior to and subsequent to the move. These customer satisfaction tasks include the steps of contacting the customer at a predetermined time before the move to elicit information about the move, and contacting the customer at a predetermined time after the moving day to elicit information about the move.

These and other unique features of the method of the subject invention will become more readily apparent from the following description of the drawings taken in conjunction with the detailed of the preferred embodiments.

### BRIEF DESCRIPTION OF THE DRAWINGS

So that those having ordinary skill in the art to which the subject invention appertains will more readily understand how to employ the method of the subject invention, reference may be had to the drawings wherein:

FIG. 1 is a flow chart depicting the preliminary steps of the move management process of the subject invention;

FIG. 2 is a flow chart depicting the steps in the truck rental management process of the subject invention;

FIG. 3 is a flow chart depicting the steps in the box provision management process of the subject invention;

FIG. 4 is a flow chart depicting the steps in the storage rental management process of the subject invention; and

FIG. 5 is a flow chart depicting the steps in the container rental management process of the subject invention.

FIG. 6. is a flow chart depicting the steps of the move management process of the subject invention; and

FIG. 7 is an illustration of a move summary screen associated with the computer system utilized in conjunction with the move management process of the subject invention.

These and other features of the method of the subject invention will become more readily apparent to those having ordinary skill in the art form the following detailed description of the preferred embodiments.

### DETAILED DESCRIPTION OF THE PREFERRED EMBODIMENTS

The subject invention is directed to a unique business model for the household goods transportation industry which incorporates a computerized move management process. The goal of the process is to provide and monitor seamless service and a quality transfer of household goods for a private moving transferee regardless of carrier utilization. The process provides revenue opportunities for real estate brokers and agents, and a moving solution for home buyers and sellers that provides significant savings, convenience and value.

At the core of the move management system of the subject invention, is a database tracking system which allows independent moving contractors to automate and tie business applications together to improve customer service through the home moving process. The computerized move management system of the subject invention is designed for instantaneous response for each relocating family and monitors all of their needs. The system provides a step-by-step, day-by-day monitoring process developed solely by the individual customer's needs to direct strategic activities and continuously contact the relocating customer, before during and after the move.

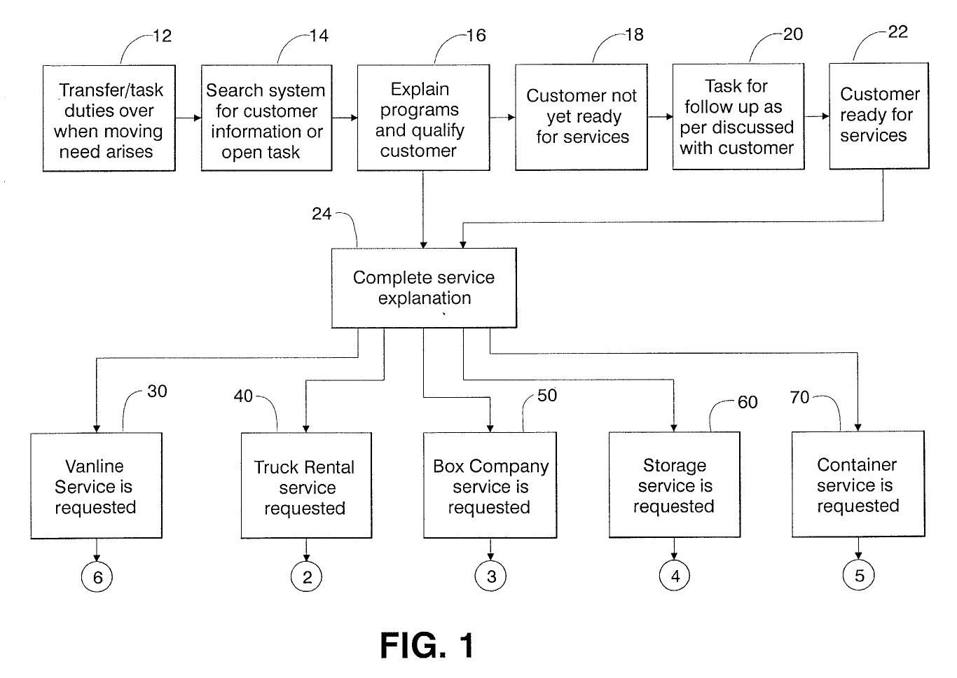

Referring now to the drawings, there is illustrated in FIG. 1 a flow chart illustrating the preliminary steps of the move management process of the subject invention, which is designated generally by reference numeral 10. During this preliminary stage, a customer (i.e., a buyer or seller of real estate) interacts with a professional move consultant who was previously engaged by the customer when the customer executed a listing agreement with a real estate agency. This relationship enables the professional move consultant to offer real estate related products and services to a customer throughout various stages of the real estate transaction process and beyond, so as to create a customer for life. This cross-selling process is the subject of commonly assigned U.S. application Ser. No. 09/459,234, the subject matter of which is incorporated herein by reference in its entirety.

In accordance with the cross-selling process of the commonly assigned '234 application, one of the services provided by a professional move consultant is household goods transportation services or moving services. When a professional move consultant determines from a customer that a move is eminent, the professional move consultant refers the customer to a national move coordinator who handles the entire moving/relocation process, before, during and after the move, including handling any damage claims the customer may have after the move. During the moving process, the computerized move management system of the subject invention enables the customer, the national move coordinator, the professional move consultant, and the referring real estate agent to monitor the moving process so as to ensure customer satisfaction over a distributed computer network, such as, for example, the Internet or World Wide Web.

Referring now to FIG. 1, once the national move coordinator receives a customer referral by phone, facsimile or e-mail from the professional move consultant, at step 12, the move coordinator searches for and accesses information about the customer from the national customer database maintained by the professional move consultant at step 14. Thereafter, at step 16 the move coordinator contacts the customer/transferee to explain and describe the specific moving services provided under the subject method, and performs a needs analysis in order to build a customized move profile.

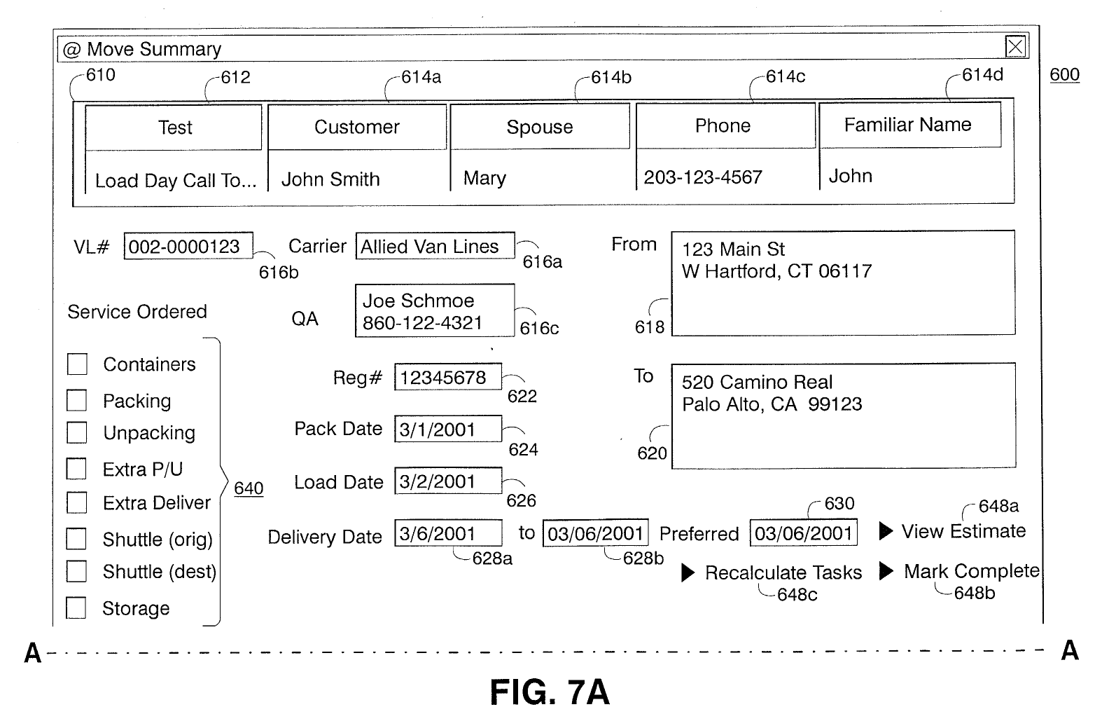

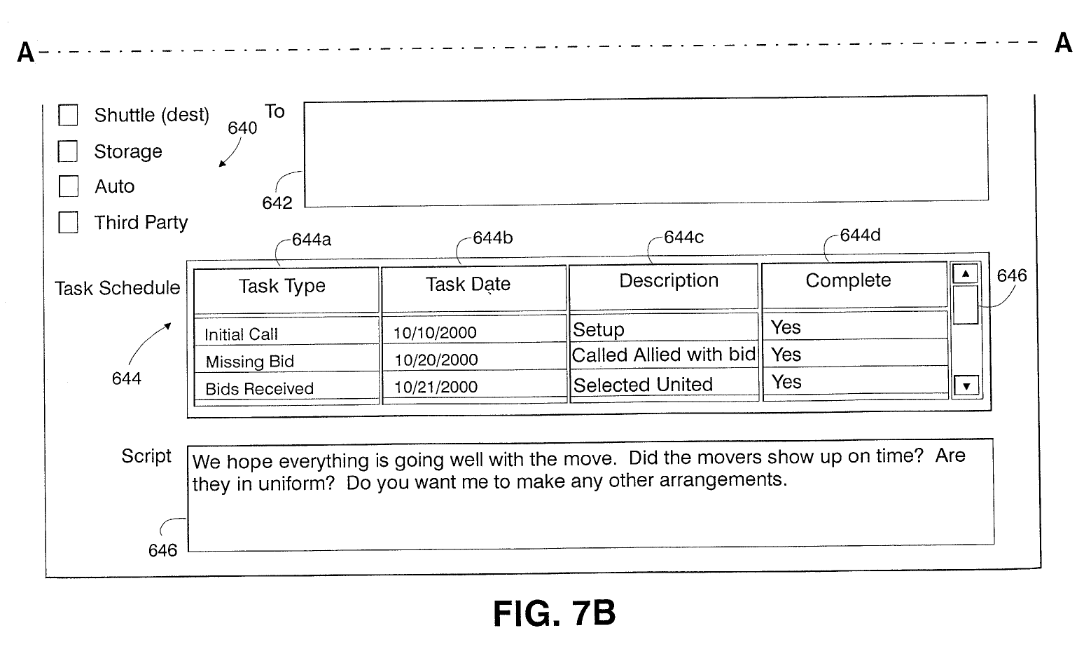

The move profile is a computerized file with a plurality of data fields relating to the customer and the move, into which the move coordinator enters information gleaned from the customer during the needs analysis. The move profile is presented on a move summary screen, see FIG. 7, which includes a task schedule for the move coordinator. The task schedule instructs the move coordinator to perform tasks relating to the customer throughout the moving process. The move summary screen, which will be discussed in greater detail hereinbelow, is also accessible by the professional move consultant for reviewing the progress of the move coordinator.

If the move coordinator determines at step 18, that the customer is not yet ready to utilize any of the moving services being offered, the move coordinator sets up a task in the customer's move profile at step 20, which will instruct the move coordinator to contact the customer at a later date, or at some specific date requested by the customer. At step 22, when the customer is ready to utilize one or more of the services being offered, the move coordinator completes the service explanation at step 24.

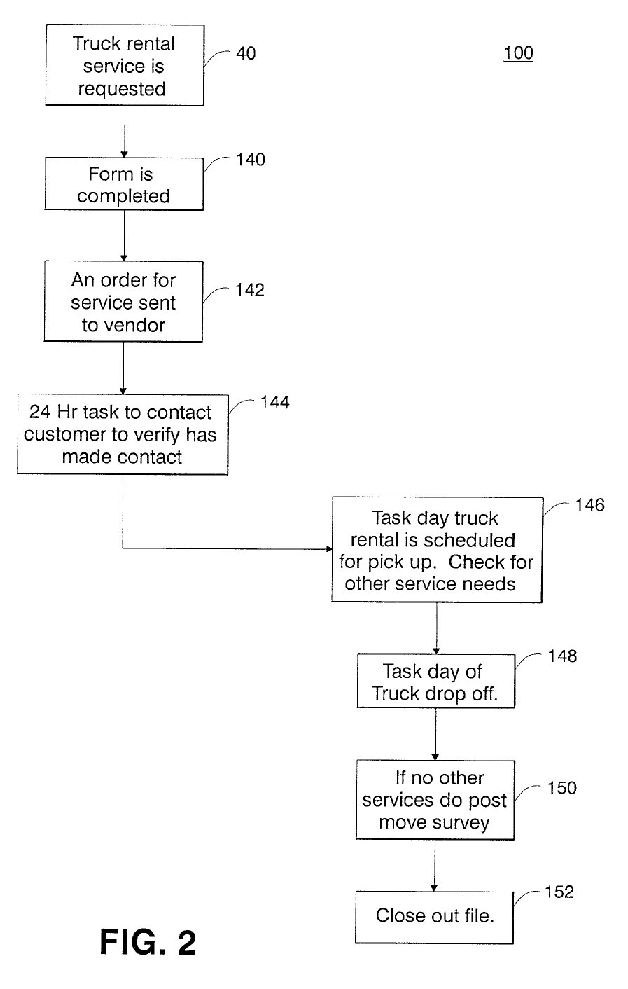

There are five (5) specific moving services that are initially offered to the customer by the move coordinator. These services including, truck rental services, box provisioning services, storage facility services, container services and vanline services, and are described below with respect to FIGS. 2 through 6. At step 30 the customer may request van line services, at step 40 the customer may request truck rental services, at step 50 the customer may request box provisioning, at step 60 the customer may request storage facility services, and at step 70 the customer may request container services.

Referring to FIG. 2, there is illustrated a flow chart depicting the steps associated with the truck rental service aspects of the subject invention, which is designated generally by reference numeral 100. The truck rental service offered by the move coordinator involves a national truck rental vendor, i.e., Penske, and the move coordinator interacts with the customer and the vendor based upon the needs analysis. Initially, upon reaching agreement with the customer, the move coordinator completes an appropriate form at step 140 and places an order with the vendor by facsimile or e-mail at step 142. The vendor must then contact the customer at step 144 to arrange the appropriate truck size, pick-up time and location, and drop-off time and location.

In accordance with the subject invention, the move coordinator is tasked to contact the customer within twenty-four hours of sending the order, to verify that the truck rental vendor has made contact with the customer. On the pick-up day, the move coordinator is tasked by the move management software at step 146 to contact the customer so as to make certain that the correct equipment was made available. Then, on the drop-off day, the move coordinator is tasked by the move management system at step 148 to contact the customer to ensure satisfaction and to determine whether any additional services are required. If it is determined at step 150 that no other services are required, the move coordinator performs a post move survey and the file is closed at step 152.

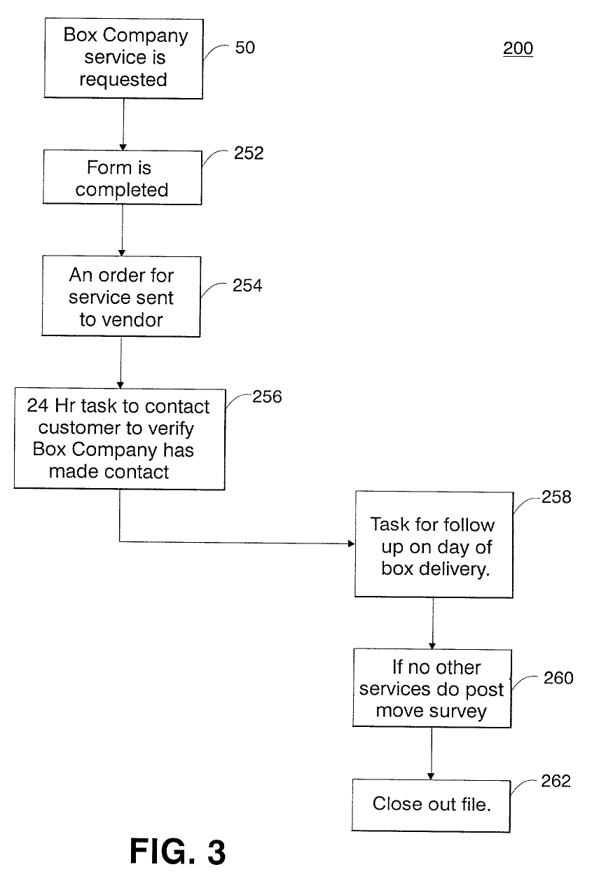

Referring to FIG. 3, there is illustrated a flow chart depicting the steps associated with the box or carton provisioning service aspects of the subject invention, which is designated generally by reference numeral 200. The box provisioning service involves a national box vendor, i.e., The Box Company, and the move coordinator interacts with the customer and the box vendor based upon the needs analysis. Upon reaching agreement with the customer, the move coordinator completes an appropriate order form at step 252 and sends the order to the box vendor by facsimile or e-mail at step 254. The box vendor must then contact the customer to arrange for the delivery of the appropriate number, size and type of shipping boxes.

In accordance with the subject invention, the move coordinator is tasked by the system to contact the customer within twenty-four hours of sending the order at step 256 to verify that the box vendor has made contact with the customer, and if the customer has made a purchase, as well as the delivery date for the boxes. The move coordinator then updates the move profile to enter the box delivery date. Consequently, on the box delivery date, the system tasks the move coordinator to contact the customer at step 258 in order to verify delivery of the boxes and to determine whether any other services are required. If it is determined at step 260 that no other services are required, the move coordinator performs a post move survey and the file is closed at step 262.

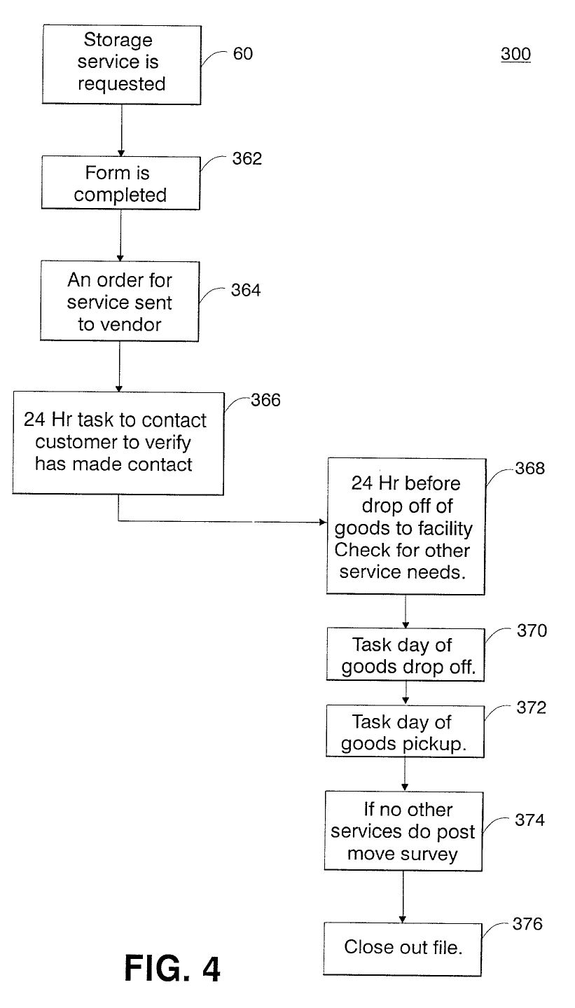

Referring to FIG. 4, there is illustrated a flow chart depicting the steps associated with the storage facility rental service aspects of the subject invention, which is designated generally by reference numeral 300. The storage facility rental service involves a national storage vendor, i.e., Shurgard, and the move coordinator interacts with the customer and the vendor based upon the needs analysis discussed above. Upon reaching agreement with the customer, the move coordinator completes an appropriate order form at step 362 and sends the order to the storage vendor by facsimile or e-mail at step 364. The storage vendor must then contact the customer to arrange for an appropriate facility size, the drop-off day and location, and the pick-up day and location.

In accordance with the subject invention, the move coordinator is tasked by the move management system at step 366 to contact the customer within twenty-four hours of sending the order to the storage vendor to verify that the vendor has made contact with the customer, and if the customer has booked a facility, and if so, the drop-off and pick-up dates. The move coordinator then updates the customer's move profile to enter the drop-off and pick-up dates. As a result, twenty-four hours before the drop-off day, the move management system tasks the move coordinator at step 368 to contact the customer in order to verify that they are on track for delivery and to determine whether any other services are needed.

Thereafter, on the day that the goods are dropped off, the system tasks the move coordinator at step 370 to verify that the correct facility size has been reserved for them. Then, on the day that the goods are picked up, the system tasks the move coordinator at step 372 to verify that the goods have been picked up and that no problems arose. At such a time, the move coordinator is tasked at step 374 to determine whether any other services are required. If no other services are required, the move coordinator performs a post move survey and the file is closed at step 376.

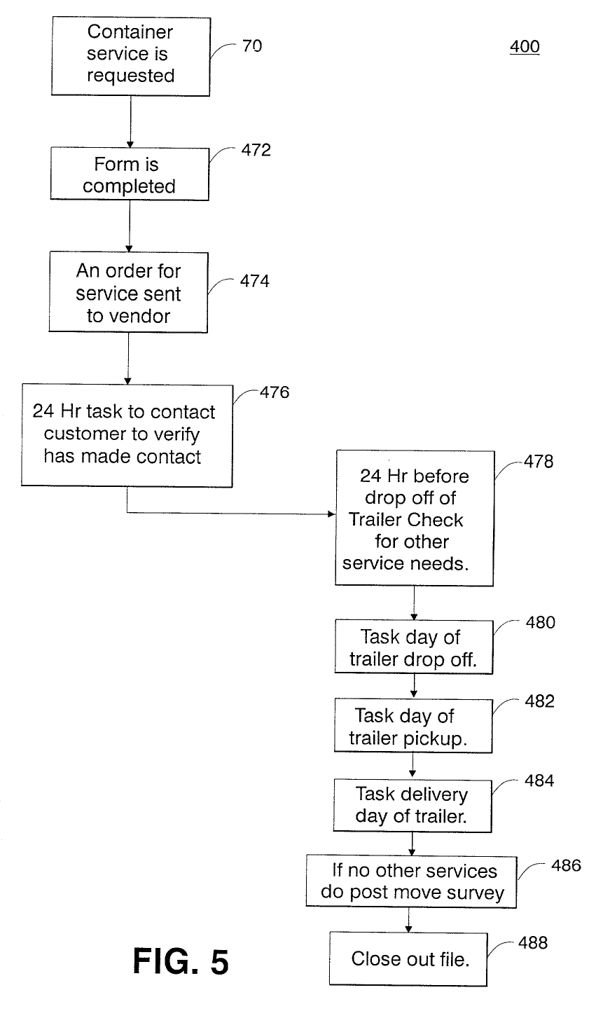

Referring to FIG. 5, there is illustrated a flow chart depicting the steps associated with the container/trailer aspects of the subject invention, which is designated generally by reference numeral 400. The container/trailer service involves a national container vendor, i.e., Move X, who delivers a mobile container/trailer at a customers home along with loading equipment, and subsequently picks-up the container with a truck and delivers it to the customers new home, either by truck or by railway. During the process of the subject invention, the move coordinator interacts with the customer and the container vendor based upon the needs analysis discussed above. As with each of the previously described services offered by the move coordinator, upon reaching agreement with the customer, the move coordinator completes an appropriate order form at step 472 and sends the order to the container vendor by facsimile or e-mail 474. The container vendor must then contact the customer to arrange for the delivery of an appropriately sized container, and delivery instruction as well as drop-off and pick-up dates for the container/trailer.

In accordance with the subject invention, the move coordinator is tasked by the move management system at step 474 to contact the customer within twenty-four hours of sending the order to the container vendor at step 474 to verify that the vendor has made contact with the customer, and if the customer has ordered a container. If an order has been placed, the drop-off and pick-up dates are determined by the move coordinator. The move coordinator then enters this information into the move profile for the customer.

With continuing reference to FIG. 5, the move coordinator is then tasked by the system at step 478 to contact the customer twenty-four hours before the trailer is dropped off at the customer's home, and to check if there are any other services required at that time, such as shipping boxes. Thereafter, on the day the trailer is to be dropped off, the system tasks the move coordinator at step 480 to contact the customer to determine whether the trailer has been delivered and if so, whether the appropriate loading equipment has been provided, such as rope and hand trucks. On the pick-up date, the system tasks the move coordinator at step 482 to contact the customer in order to verify that the trailer/container has been picked up. Finally, on the date the container is delivered to the customer's home, the system tasks the move coordinator at step 484 to contact the customer to determine whether the container has been delivered, and to determine whether any other services are required. If it is determined at step 486 that no other services are required, the move coordinator performs a post move survey and the customer's file is closed step 488.

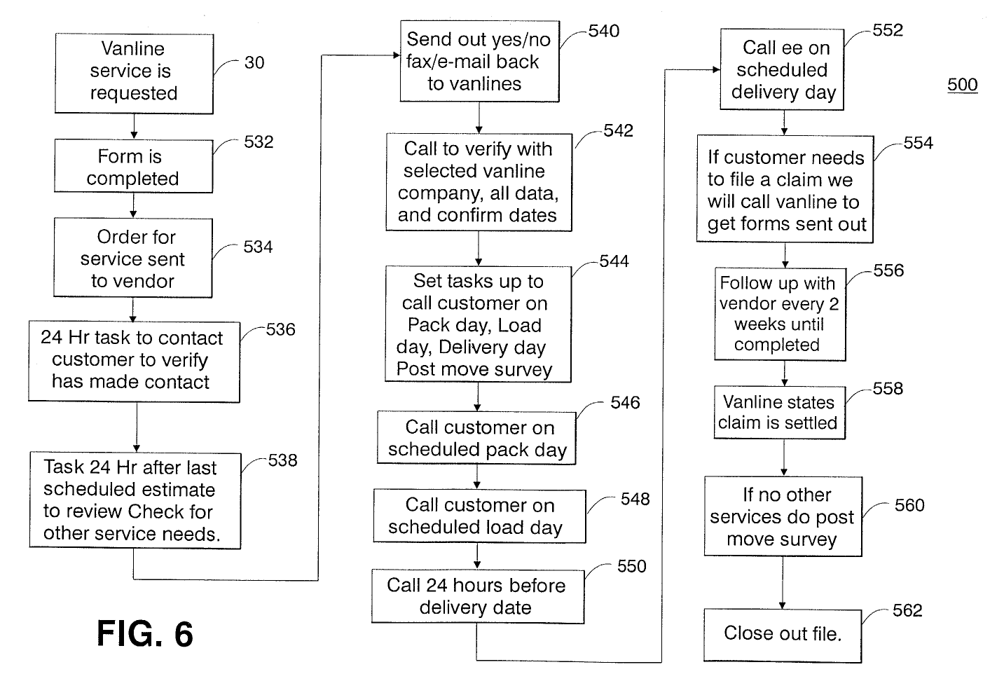

Referring to FIG. 6, there is illustrated a flow chart depicting the steps associated with the vanline services aspects of the subject invention, which is designated generally by reference numeral 500. The van line service involves carrier/vendors, and the move coordinator interacts with the customer and carriers based upon the needs analysis described previously. Initially, upon reaching agreement with the customer, the move coordinator prepares a preliminary move file, completes an appropriate form at step 532, and places an order for services with a number of carriers by facsimile or e-mail at step 534. The number of orders placed is based upon the number of estimates required by the customer. This preference is determined by the move coordinator during the needs analysis discussed previously.

Each carrier must then contact the customer within twelve hours of receiving the order for service from the move coordinator to schedule an in-home survey so as to formulate a cost estimate for the move. In accordance with the subject invention, the move coordinator is tasked by the move management system at step 536 to contact the customer within twenty-four hours of sending the order, to verify that each carrier has made contact with the customer, and to determine when the last survey appointment has been scheduled. Then, twenty-four hours after the last scheduled appointment, the move coordinator is tasked at step 538 to contact the customer to determine whether they have made a decision on a particular carrier/vanline.

If a decision was made, the move coordinator determines the pack, load and delivery dates. If they did not make a decision, the move coordinator will review the estimates with the customer in an effort to make a decision. Once the customer has decided which vanline to engage, the move coordinator forwards an order for service to the selected carrier by facsimile or e-mail at step 540. Thereafter, at step 542 the move coordinator is tasked to contact the selected carrier to verify information related to the registered dates for packing, loading and delivery. Once verified, the move summary screen of FIG. 7 is updated at step 544, and a series of tasks are configured for the move coordinator based upon the registered dates.

On the pack day, the move coordinator is tasked by the move management software at step 546 to contact the customer to make certain that the movers have arrived as scheduled. Then, on the load day, the move coordinator is tasked at step 548 to contact the customer to make ensure that loading has begun. Twenty-four hours before the delivery date, the move coordinator is tasked at step 550 to contact the carrier to verify the delivery date. On the scheduled delivery date, the move coordinator is tasked at step 552 to contact the customer to verify that the movers have arrived and have begun to unload the customer's belongings.

Two weeks after the delivery date, or sooner, the move coordinator is tasked at step 556 to contact the customer to determine whether the customer needs to file a claim for damages caused during the move, and if so, the move coordinator contacts the carrier and instructs them to forward claim forms to the customer. The move coordinator is tasked at step 556 to contact the customer every two weeks thereafter to verify that the claim has been completed. Once all claims have been completed, the move coordinator is tasked by the move management system at step 558 to contact the customer to ensure satisfaction and determine whether any additional services are required. If no other services are required, the move coordinator performs a post move survey at step 560 and the customer's file is closed at step 562.

Referring now to FIG. 7, there is illustrated a move summary screen displayed on a computer monitor associated with a computer system upon which the move management system of the subject invention resides. The move summary screen is designated generally by reference numeral 600. Move summary screen 600 has a principle task region 610 that includes a task description field 612, and a set of customer identification data fields 614a-614d wherein the names and phone numbers of the customers are presented. Below the principle task region 610, there is a plurality of fields containing information related to the move. For example, this region of the screen includes fields 616a-616c identifying the carrier/vanline selected by the customer based upon the bidding process of the subject invention, by name and number, as well as a field for the name and phone number of the mover who will perform the move. In addition, this region of the summary screen includes fields 618 and 620 for identifying the addresses from and to which the customer is moving, respectively.

The move summary screen 600 also includes a field 622 for entering a registration number for the customer/move, as well as fields 624 and 626 to enter and display the pack date and load date. Fields are also provided for entering the delivery dates, including a date range in fields 628a, 628b and a preferred delivery date at field 630. The move information and dates are determined by the move coordinator during the initial needs analysis. On the far left of the move summary screen 600, there is displayed a list of services 640 that are offered to the customer by the move coordinator. Each service has a corresponding box that may be checked by the move coordinator. These include containers, packing, unpacking, extra p/u, extra deliver, shuttle (orig), shuttle (dest), storage, auto and third party.

The move summary screen 600 also includes a comments window 642 which allows the move coordinator to enter notes and reminders relating to the services provided by a vendor or tasks performed by the move coordinator or move consultant. A task schedule window 644 with a scroll feature 646 is located below the comments window 642. The task schedule window 644 has four columns including a field 644a for describing the type of task to be performed by the move coordinator (i.e., initial call, bid receipt inquiry), a field 644b for the date the task is to be performed by the move coordinator, a field 644c for the description of the task performed by the move coordinator (i.e., a customer vendor selection), and a field 644d for indicating whether the task has been completed.

The move summary screen 600 also includes a script window 646 which presents a prearranged set of questions that the move coordinator may ask a customer during various stages of the move management process. The questions are generally related to customer satisfaction and are used to determine whether vendors are performing in accordance with specific guidelines. Certain questions may be provided by a vendor. To the right of the delivery date fields, are action flags that may be selected by the move coordinator to view estimates from vendors, recalculate tasks and mark tasks complete. When the “View Estimates” flag 648a is selected, an estimate screen is raised which lists the bids provided by various vendors. When the “Recalculate Tasks” flag 648b is selected, the task schedule is updated, and when the “Mark Complete” flag 648c is selected the appropriate field in the task schedule is marked.

In accordance with a preferred embodiment of the subject invention, if at any time during the move management process of the subject invention, the move coordinator determines that services offered by the professional move consultant are required by the customer, such as, for example, telephone, electric or cable television service start-up, the move consultant enters the move management system, and schedules an appropriate task for the move consultant to perform.

Although the disclosed method has been described with respect to preferred embodiments, it is apparent that modifications and changes can be made thereto without departing from the spirit and scope of the invention as defined by the appended claims.

What is claimed is:

1. A method of facilitating a move of household goods for a customer comprising the steps of:
a) receiving contact information relating to a customer from a referral source;
b) contacting the customer to perform a pre-move needs analysis;
c) offering the customer at least one moving service based upon the pre-move needs analysis;
d) sending an order to a vendor for a selected moving service on behalf of the customer; and
e) performing a set of predefined tasks based upon a schedule of events related to the selected moving service to ensure customer satisfaction throughout a move.

2. A method according to claim 1, wherein the at least one moving service is selected from a group of moving services including transportation services, truck rental services, box provision services, container services, and storage facility services.

3. A method according to claim 1, wherein the step of sending an order to a vendor includes the step of sending an order over a distributed communication network

4. A method according to claim 1, further comprising the step of creating a computerized move profile based upon the needs analysis.

5. A method according to claim 4, further comprising the step of entering a set of dates into the move profile related to a selected moving service.

6. A method according to claim 5, further comprising the step of generating a task schedule for a selected moving service based upon the set of dates entered into the move profile.

7. A method according to claim 1, wherein the step of performing a predefined set of tasks includes contacting the service provider after a predetermined time period to verify they have contacted the customer.

8. A method according to claim 1, wherein the step of performing a predefined set of tasks includes contacting a vendor on a specific date to confirm the set of dates.

9. A method according to claim 1, wherein the step of performing a predefined set of tasks includes contacting the customer on a specific date to verify an appropriate action by the vendor

10. A method according to claim 1, wherein the step of performing a predefined set of tasks includes contacting the customer on a specific date to conduct a post-move survey.

11. A method of facilitating a move of household goods by a carrier comprising the steps of:
a) determining a number of cost estimates required by a customer;
b) contacting a number of carriers within a geographic region corresponding to the number of cost estimates required by the customer;
c) arranging for each carrier to conduct a survey of the customer's home to determine a cost estimate for the move; and
d) awarding a move to the carrier selected by the customer based upon cost the estimates received from each carrier.

12. A method according to claim 11, further comprising the step of receiving a cost estimate from each carrier based upon the survey conducted thereby.

13. A method according to claim 11, further comprising the step of conferring with the customer to facilitate the selection of a carrier based upon the cost estimates received from each carrier.

14. A method according to claim 11, wherein the step of arranging for each carrier to conduct a survey of the customer's home includes the step of scheduling surveys at predetermined time intervals.

15. A method according to claim 11, further comprising the step designating a time period for each carrier to contact the customer to schedule the survey.

16. A method according to claim 11, further comprising the step of designating a time period for each carrier to submit a cost estimate to the customer.

17. A method according to claim 16, further comprising the step of designating a rule defining a method for submitting a cost estimates to the customer.

18. A method according to claim 11, further comprising the step of receiving contact information relating to the customer from a referral source.

19. A method according to claim 11, further comprising the step of calculating a commission fee based upon the cost of the move and at least one business rule.

20. A method according to claim 11, further comprising the step of creating a computerized move profile for the customer.

21. A method according to claim 20, further comprising the step of entering a set of dates into the computerized move profile related to the move.

22. A method according to claim 21, further comprising the step of generating a task schedule based upon the set of dates entered into the computerized move profile.

23. A method according to claim 21, further comprising the step of performing a set of predefined tasks based upon a schedule of events related to the move to ensure customer satisfaction prior to, during and after the move.

24. A method according to claim 11, further comprising the step of contacting each carrier in accordance with a rule defining a method of contact.

25. A method of facilitating a move of household goods by a carrier comprising the steps of:
a) receiving contact information relating to a customer from a referral source;
b) contacting the customer to perform a pre-move survey;
c) determining a number of cost estimates required by the customer;
d) contacting a number of carriers in a particular geographic region corresponding to the number of cost estimates required by the customer;
e) arranging for each carrier to conduct a survey of the customer's home to enable each carrier to determine a cost estimate for the move at predetermined time intervals;
f) conferring with the customer to facilitate the selection of a carrier based upon the cost estimates received from each carrier; and
g) awarding a move to the carrier selected by the customer.

26. A method according to claim 25, further comprising the step designating a time period for each carrier to contact the customer to schedule the survey.

27. A method according to claim 25, further comprising the step of designating a time period for each carrier to submit a cost estimate to the customer.

28. A method according to claim 27, further comprising the step of designating a rule defining a method for submitting a cost estimates to the customer.

29. A method according to claim 25, further comprising the step of creating a computerized move profile for the customer.

30. A method according to claim 29, further comprising the step of entering a set of dates into the computerized move profile related to the move.

31. A method according to claim 30, further comprising the step of generating a task schedule based upon the set of dates entered into the computerized move profile.

32. A method according to claim 31, further comprising the step of performing a set of predefined tasks based upon a schedule of events related to the move to ensure customer satisfaction prior to, during and after the move.
